(19) United States
(12) Patent Application Publication
(10) Pub. No.: US 2026/0005760 A1
(43) Pub. Date: Jan. 1, 2026

(54) TRANSFER FUNCTION ESTIMATION DEVICE, TRANSFER FUNCTION ESTIMATION METHOD AND PROGRAM

(71) Applicant: NIPPON TELEGRAPH AND TELEPHONE CORPORATION, Tokyo (JP)

(72) Inventors: Masanori NAKAMURA, Musashino-shi (JP); Takeo SASAI, Musashino-shi (JP); Etsushi YAMAZAKI, Musashino-shi (JP); Yoshiaki KISAKA, Musashino-shi (JP); Takashi SAIDA, Musashino-shi (JP)

(73) Assignee: NIPPON TELEGRAPH AND TELEPHONE CORPORATION, Tokyo (JP)

(21) Appl. No.: 18/992,265

(22) PCT Filed: Jul. 13, 2022
(86) PCT No.: PCT/JP2022/027498

§ 371 Date: Jan. 8, 2025

(51) Int. Cl. H04B 10/073; H04B 10/548

(52) U.S. Cl. CPC H04B 10/073; H04B 10/548

(57) ABSTRACT

A transfer function estimation device includes a composite transfer function calculation unit that calculates a composite transfer function which is obtained by combining a transmission transfer function that affects a signal transmitted by an optical transmitter and a reception transfer function that affects a signal received by an optical receiver in each of frequency offsets that are differences between a frequency of a carrier wave input to an optical modulation unit in the optical transmitter and a frequency of a carrier wave input to an optical demodulation unit in the optical receiver based on a signal transmitted by the optical transmitter and a signal received by the optical receiver, and a transfer function separation unit that calculates the transmission transfer function and the reception transfer function from the composite transfer function based on dependency of the composite transfer function on the frequency offset.

### TECHNICAL FIELD

The present invention relates to a transfer function estimation device, a transfer function estimation method, and a program.

### BACKGROUND ART

In order to increase the capacity of optical transmission, it is required to improve the accuracy of the imperfection compensation of a transmitter-receiver. PTL 1 discloses a method of estimating a transfer function of a transmitter-receiver using white noise and a known signal sequence. PTL 2 discloses a method for reducing mixing of phase characteristics on a receiver side into phase characteristics on a transmitter side in estimation of transfer functions of the transmitter-receiver by averaging the transfer functions of the transmitter-receiver obtained when changing the frequency offset.

However, in the method disclosed in PTL 1, a white noise source different from the transmitter-receiver is required to obtain a temporary reception-side transfer function, and in order to obtain a transmission-side transfer function after obtaining the temporary reception-side transfer function and then to precisely estimate the reception-side transfer function, there is a drawback that the number of processing steps is increased. Also in the method disclosed in PTL 2, it is difficult to completely separate the phase characteristics on the receiver side from the phase characteristics on the transmitter side depending on the phase characteristics on the receiver side.

### CITATION LIST

### Patent Literature

PTL 1: Japanese Patent No. 6428881
PTL 2: Japanese Patent No. 6984784

### Non Patent Literature

NPL 1: Umberto Mengali and Michele Morelli. 1997. “Data-aided frequency estimation for burst digital transmission” IEEE Transactions on Communications 45(1):23-25.

### SUMMARY OF INVENTION

### Technical Problem

In view of the above-mentioned circumstances, the present invention aims to provide a technique for estimating a transmission function on the transmission side and a transmission function on the reception side with fewer steps.

### Solution to Problem

An aspect of the present invention is a transfer function estimation device including a composite transfer function calculation unit that calculates a composite transfer function which is obtained by combining a transmission transfer function that affects a signal transmitted by an optical transmitter and a reception transfer function that affects a signal received by an optical receiver in each of frequency offsets that are differences between a frequency of a carrier wave input to an optical modulation unit in the optical transmitter and a frequency of a carrier wave input to an optical demodulation unit in the optical receiver based on a signal transmitted by the optical transmitter and a signal received by the optical receiver, and a transfer function separation unit that calculates the transmission transfer function and the reception transfer function from the composite transfer function based on dependency of the composite transfer function on the frequency offset.

### Advantageous Effects of Invention

According to the present invention, the transfer function on the transmission side and the transfer function on the reception side can be estimated with fewer steps.

### BRIEF DESCRIPTION OF DRAWINGS

FIG. 1 is a diagram illustrating a configuration example of a transmission and reception system 1 according to an embodiment.

FIG. 2 is a diagram illustrating a configuration example of a transfer function estimation device 4 according to the embodiment.

FIG. 3 is a diagram illustrating a composite transfer function, a frequency offset, an amplitude characteristic, and a phase characteristic recorded in a storage unit 43.

FIG. 4 is a flowchart illustrating an operation of the transfer function estimation device 4.

FIG. 5 is a diagram illustrating amplitude characteristics and phase characteristics of a transmission transfer function and a reception transfer function calculated by the transfer function estimation device 4.

### DESCRIPTION OF EMBODIMENTS

### Embodiment

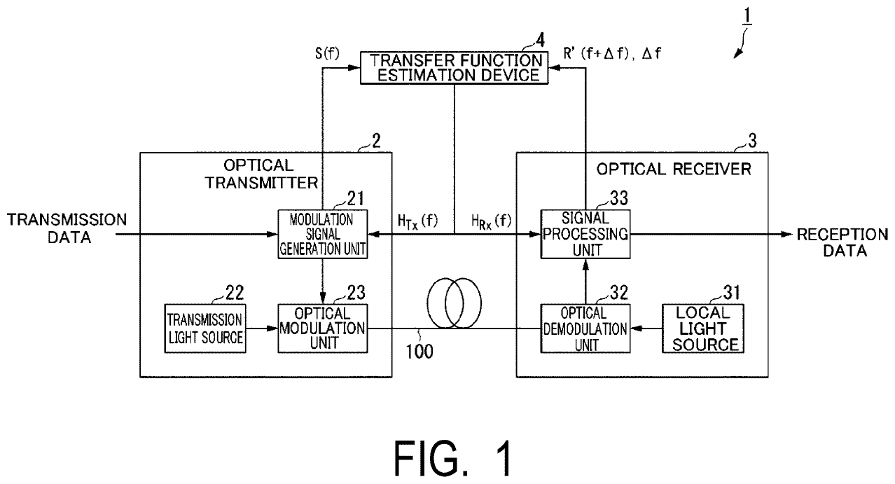

FIG. 1 is a diagram illustrating a configuration example of a transmission and reception system 1 of an embodiment. The transmission and reception system 1 includes an optical transmitter 2, an optical receiver 3, a transfer function estimation device 4, and an optical transmission line 100. In the transmission and reception system 1, the optical transmitter 2 generates an optical modulation signal from the input transmission data and outputs the signal to the optical receiver 3 via the optical transmission line 100. The optical receiver 3 generates and outputs reception data from the optical modulation signal. The transfer function estimation device 4 estimates a transfer function used by the optical transmitter 2 and the optical receiver 3.

The optical transmitter 2 includes a modulation signal generation unit 21, a transmission light source 22, and an optical modulation unit 23. The modulation signal generation unit 21 converts input transmission data from bit data to a symbol sequence. The modulation signal generation unit 21 performs digital signal processing on the symbol sequence to generate a transmission waveform sequence s (t). The digital signal processing performed by the modulation signal generation unit 21 is, for example, spectrum shaping or pre-equalization of a transfer function (hereinafter, referred to as a transmission transfer function) of the optical transmitter 2. The transmission waveform sequence after the transmission transfer function H_{Tx}(f) is received is expressed by Equation (1) using S(f) which is a frequency domain representation of s(t) (after a Fourier transform).

$$\begin{matrix}[ Math . 1 ] & \\ {S}^{′} ( f ) = {H}_{Tx} ( f ) S ( f ) & ( 1 )\end{matrix}$$

Here, S′(f) is a frequency domain representation of a transmission waveform sequence affected by the transmission transfer function H_{Tx}(f). The modulation signal generation unit 21 outputs S(f) to the transfer function estimation device 4.

The modulation signal generation unit 21 performs digital-to-analogue conversion of a signal subjected to digital signal processing to generate a modulation signal in a baseband region. The optical modulation unit 23 generates an optical modulation signal based on the modulation signal and a carrier wave of a frequency f_{sig} output from the transmission light source 22, and outputs the optical modulation signal to the optical receiver 3. An electric field signal E(f) of the optical modulation signal modulated by the carrier wave of the frequency f_{sig} in the baseband region is expressed by Equation (2).

$$\begin{matrix}[ Math . 2 ] & \\ E ( f ) = {H}_{Tx} ( f - {f}_{sig} ) S ( f - {f}_{sig} ) & ( 2 )\end{matrix}$$

The optical receiver 3 includes a local light source 31, an optical demodulation unit 32, and a signal processing unit 33. The optical demodulation unit 32 converts an optical modulation signal received from the optical transmitter 2 via the optical transmission line 100 into a baseband signal by the carrier wave of a frequency fₗₒ output from the local light source 31. The baseband signal R(f) generated by the optical demodulation unit 32 is expressed by Equation (3).

$$\begin{matrix}[ Math . 3 ] & \\ R ( f ) = {H}_{Tx} ( f - Δ f ) S ( f - Δ f ) & ( 3 )\end{matrix}$$

Here, Δf is a frequency offset between the transmission light source 22 and the local light source 31, and Δf=f_{sig}−fₗₒ. The signal processing unit 33 converts the baseband signal from an analogue signal to a digital signal, and performs digital signal processing. The digital signal processing performed by the signal processing unit 33 is, for example, spectrum shaping or equalization of a transfer function (hereinafter, referred to as a reception transfer function) of the optical receiver 3. The signal R′ (f), which is a signal affected by the reception transfer function H_{Rx}(f), is expressed by Equation (4).

$$\begin{matrix}[ Math . 4 ] & \\ {R}^{′} ( f ) = {H}_{Rx} ( f ) {H}_{Tx} ( f - Δ f ) S ( f - Δ f ) & ( 4 )\end{matrix}$$

The signal processing unit 33 estimates Δf from R(f) and S(f). The signal processing unit 33 estimates Δf by a method disclosed in, for example, NPL 1, which is a method of converting a baseband signal from an analogue signal to a digital signal, and then estimating a frequency offset from a temporal change in a phase relationship between r(t) and a transmission signal waveform s(t). Here, r(t) is the inverse Fourier transform of the reception signal. The signal processing unit 33 outputs the R′(f) to the transfer function estimation device 4. The signal processing unit 33 may output R′(f) as reception data to the outside.

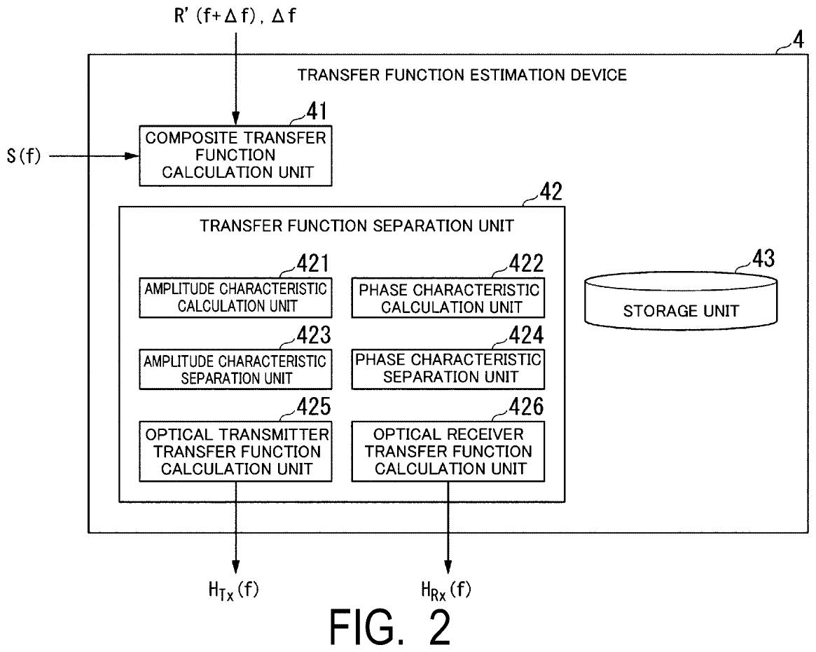

FIG. 2 is a diagram illustrating a configuration example of the transfer function estimation device 4 according to the embodiment. The transfer function estimation device 4 includes a composite transfer function calculation unit 41, a transfer function separation unit 42, and a storage unit 43. The composite transfer function calculation unit 41 calculates the composite transfer function by changing the frequency offset Δf. These components are realized by, for example, a hardware processor such as a central processing unit (CPU) executing a program (software). Note that all or some of these functional units may be realized by hardware (circuit part; including circuitry) such as large scale integration (LSI), an application specific integrated circuit (ASIC), a field-programmable gate array (FPGA), a graphics processing unit (GPU), or the like, or may be realized by software and hardware in cooperation. The program may be stored in a storage device (a storage device provided with a non-transitory storage medium) such as a hard disk drive (HDD) or a flash memory in advance, or may be stored in a removable storage medium (a non-transitory storage medium) such as a DVD or a CD-ROM, and installed by mounting the storage medium on the drive device.

A specific calculation method will be described below. The composite transfer function calculation unit 41 acquires a frequency offset Δf from the optical receiver 3. The composite transfer function calculation unit 41 may acquire by receiving Δf by estimating Δf by, for example, a method similar to that of the signal processing unit 33, or may acquire Δf estimated by the signal processing unit 33 from the optical receiver 3. The composite transfer function calculation unit 41 compensates for R′(f) by Δf. The composite transfer function calculation unit 41 may compensate for wavelength dispersion, polarization mode dispersion, and polarization rotation occurring in the optical fiber of the optical transmission line 100 at this time. Further, the composite transfer function calculation unit 41 may also compensate for phase noise between the transmission light source 22 and the local light source 31. The compensated signal R′(f+Δf) is expressed by Equation (5).

$$\begin{matrix}[ Math . 5 ] & \\ {R}^{′} ( f + Δ f ) = {H}_{Rx} ( f + Δ f ) {H}_{Tx} ( f ) S ( f ) & ( 5 )\end{matrix}$$

The composite transfer function calculation unit 41 calculates H_{Rx}(f+Δf)H_{Tx}(f) obtained by dividing R′(f+Δf) by S(f) as a composite transfer function H_{TRx} (f, Δf). Here, the frequency offset Δf can be changed by changing the frequency setting value of one or both of the transmission light source 22 and the local light source 31. A value of the frequency offset Δf is changed by a computer, a user, or the like, and the composite transfer function calculation unit 41 calculates the composite transfer function that differs by Δf. For example, when the value of Δf takes Δf₁, Δf₂, . . . , and Δfₙ, the composite transfer function calculation unit 41 calculates composite transfer functions H_{TRx} (f, Δf₁), H_{TRx} (f, Δf₂), . . . , and H_{TRx} (f, Δfₙ). The composite transfer function calculation unit 41 records the calculated composite transfer functions in the storage unit 43 in association with the frequency offset.

The transfer function separation unit 42 calculates estimated values of a transmission transfer function H_{Tx}(f) and a reception transfer function H_{Rx}(f) of the composite transfer function H_{TRx}(f, Δf) based on dependency of a frequency offset Δf in the composite transfer function H_{TRx} (f, Δf). A specific separation method will be described below.

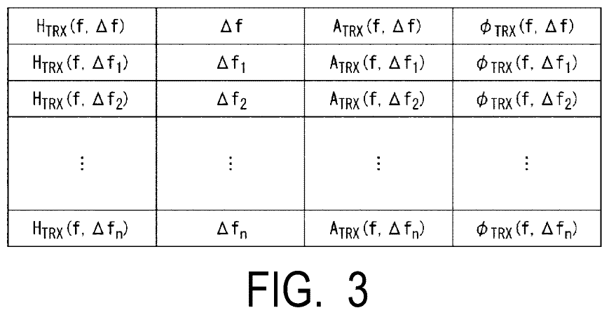

The transfer function separation unit 42 includes an amplitude characteristic calculation unit 421, a phase characteristic calculation unit 422, an amplitude characteristic separation unit 423, a phase characteristic separation unit 424, an optical transmitter transfer function calculation unit 425 and an optical receiver transfer function calculation unit 426. The amplitude characteristic calculation unit 421 calculates amplitude characteristics of composite transfer functions H_{TRx} (f, Δf₁), H_{TRx} (f, Δf₂), . . . and H_{TRx} (f, Δfₙ). The phase characteristic calculation unit 422 calculates phase characteristics of composite transfer functions H_{TRx} (f, Δf₁), H_{TRx} (f, Δf₂), . . . , and H_{TRx} (f, Δfₙ). The amplitude characteristic calculation unit 421 records the calculated amplitude characteristic in the storage unit 43, and the phase characteristic calculation unit 422 records the calculated phase characteristic in the storage unit 43. FIG. 3 is a diagram illustrating the composite transfer function, the frequency offset, the amplitude characteristic, and the phase characteristic recorded in the storage unit 43. The amplitude characteristic and the phase characteristic for different frequency offsets Δf are recorded in the storage unit 43.

An amplitude characteristic A(F) and a phase characteristic φ(f) are defined by Equations (6) and (7) by a transfer function H(F).

$$\begin{matrix}[ Math . 6 ] & \\ A ( f ) ≡ 20 {log}_{10} \vert H ( f ) \vert & ( 6 )\end{matrix}$$

$$\begin{matrix}[ Math . 7 ] & \\ ϕ ( f ) ≡ arg ∠ ( H ( f ) ) & ( 7 )\end{matrix}$$

From Equation (6) and H_{TRx} (f, Δf)=H_{Rx} (f+Δf)H_{Tx}(f), an amplitude characteristic A_{TRx} (f, Δf) of H_{TRx} (f, Δf) is expressed by Equation (8) using an amplitude characteristic A_{Rx} (f+Δf) of H_{Rx} (f+Δf) and an amplitude characteristic A_{Tx} (f) of H_{Tx}(f).

$$\begin{matrix}[ Math . 8 ] & \\ {A}_{TRx} ( f , Δ f ) = {A}_{Rx} ( f + Δ f ) + {A}_{Tx} ( f ) & ( 8 )\end{matrix}$$

Further, from Equation (7) and H_{TRx} (f, Δf)=H_{Rx} (f+Δf)H_{Tx}(f), a phase characteristic φ_{TRx} (f, Δf) of φ_{TRx} (f, Δf) is expressed by Equation (9) using a phase characteristic φ_{Rx} (f+Δf) of H_{Rx} (f+Δf) and a phase characteristic φ_{Tx}(f) of H_{Tx}(f).

$$\begin{matrix}[ Math . 9 ] & \\ {ϕ}_{TRx} ( f , Δ f ) = {ϕ}_{Rx} ( f + Δ f ) + {ϕ}_{Tx} ( f ) & ( 9 )\end{matrix}$$

Equation (8) indicates that the amplitude characteristic of the composite transfer function depends only on the amplitude characteristic of the transfer function of the receiver with respect to the change of Δf. Equation (9) indicates that the phase characteristic of the composite transfer function depends only on the phase characteristic of the transfer function of the receiver with respect to the change of Δf.

The amplitude characteristic separation unit 423 calculates the amplitude characteristic A_{Tx}(f) of the transmission transfer function and the amplitude characteristic A_{Rx}(f) of the reception transfer function based on the dependency of the amplitude characteristics A_{TRx} (f, Δf₁), A_{TRx} (f, Δf₂), . . . , and A_{TRx} (f, Δfₙ) of the composite transfer functions H_{TRx} (f, Δf₁), H_{TRx} (f, Δf₂), . . . , and H_{TRx} (f, Δfₙ) on Δf. The amplitude characteristic separation unit 423 performs polynomial fitting for, for example, Δ_{TRx} (f, Δf) with respect to Δf by Equation (10).

$$\begin{matrix}[ Math . 10 ] & \\ {A}_{TRx} ( f , Δ f ) = {a}_{0} ( f ) + {a}_{1} ( f ) Δ f + {a}_{2} ( f ) {( Δ f )}^{2} + {a}_{3} ( f ) {( Δ f )}^{3} + … & ( 10 )\end{matrix}$$

The amplitude characteristic separation unit 423 uses the amplitude characteristics A_{TRx} (f, Δf₁), A_{TRx} (f, Δf₂), . . . , and A_{TRx} (f, Δfₙ) recorded in the storage unit 43. The amplitude characteristic separation unit 423 calculates at least a₀(f) and a₁(f) by Equation (10).

In Equation (10), a₁(f) is a partial derivative around Δf=0, and is expressed by Equation (11).

$$\begin{matrix}[ Math . 11 ] & \\ \begin{matrix}{a}_{1} ( f ) = {( \frac{\partial {A}_{TRx} ( f , Δ f )}{\partial Δ f} )}_{Δ f = 0} \\ = {lim}_{h \to 0} \frac{{A}_{Rx} ( f + h ) - {A}_{Rx} ( f )}{h} \\ = \frac{{dA}_{Rx} ( f )}{df}\end{matrix} & ( 11 )\end{matrix}$$

Equation (11) is derived from Equation (8). The amplitude characteristic separation unit 423 calculates A_{Rx}(f) by integrating a₁(f) with a frequency f (Equation (12)).

$$\begin{matrix}[ Math . 12 ] & \\ \begin{matrix}\int {a}_{1} ( f ) df = \int \frac{{dA}_{Rx} ( f )}{df} df \\ = {A}_{Rx} ( f ) + C\end{matrix} & ( 12 )\end{matrix}$$

In Equation (12), C is an integral constant. The amplitude characteristic separation unit 423 can calculate A_{Rx}(f) by assuming the integral constant C to satisfy the constraint condition of A_{Rx}(0)=0, for example. This corresponds to the constraint that the amplitude of the DC component does not change in the optical receiver 3.

The amplitude characteristic separation unit 423 calculates A_{Tx}(f) based on a₀(f) and A_{Rx}(f). A_{Tx}(f) is expressed by Equation (13).

$$\begin{matrix}[ Math . 13 ] & \\ {A}_{Tx} ( f ) = {A}_{TRx} ( f , 0 ) - {A}_{Rx} ( f ) = {a}_{0} ( f ) - \int {a}_{1} ( f ) df + C & ( 13 )\end{matrix}$$

The amplitude characteristic separation unit 423 may calculate the integral constant C on the assumption of a change in amplitude of a DC component in the optical transmitter 2. In addition, since the relative relationship between frequencies is important for amplitude characteristics, assuming that an integration constant C=0, C₁ and C₂ are added to each of them after A_{Tx}(f) and A_{Rx}(f), the amplitude characteristics may be calculated by setting A_{Tx}(f)+C₁ and A_{Rx}(f)+C₂, and giving a constraint condition that the amplitude in the DC component is not changed in the optical receiver 3 and the optical transmitter 2. As described above, the amplitude characteristic separation unit 423 can calculate A_{Tx}(f) and A_{Rx}(f).

The phase characteristic separation unit 424 calculates phase characteristics φ_{Tx}(f) and φ_{Rx}(f) in the same manner as A_{Tx}(f) and A_{Rx}(f). The phase characteristic separation unit 424 calculates the phase characteristic φ_{Tx}(f) of the transmission transfer function and the amplitude characteristic φ_{Rx}(f) of the reception transfer function based on the dependency of the phase characteristics φ_{TRx} (f, Δf₁), φ_{TRx} (f, Δf₂), . . . and φ_{TRx} (f, Δfₙ) of the composite transfer functions H_{TRx} (f, Δf₁), H_{TRx} (f, Δf₂), . . . , and H_{TRx} (f, Δfₙ) on Δf. The phase characteristic separation unit 424 performs polynomial fitting of φ_{TRx} (f, Δf) with respect to Δf by Equation (14). In the phase characteristics, after unwrapping processing is applied to the phase characteristics φ_{FRx} (f, Δf₁), φ_{TRx} (f, Δf₂), . . . , and φ_{TRx} (f, Δfₙ), and polynomial fitting is performed.

$$\begin{matrix}[ Math . 14 ] & \\ {ϕ}_{TRx} ( f , Δ f ) = {b}_{0} ( f ) + {b}_{1} ( f ) Δ f + {b}_{2} ( f ) {( Δ f )}^{2} + {b}_{3} ( f ) {( Δ f )}^{3} + … & ( 14 )\end{matrix}$$

The phase characteristic separation unit 424 uses the phase characteristics φ_{TRx} (f, Δf₁), φ_{TRx} (f, Δf₂), . . . , and φ_{TRx} (f, Δfₙ) recorded in the storage unit 43. The phase characteristic separation unit 424 calculates at least b₀(f) and b₁(f) by Equation (14).

In Equation (14), b₁(f) is a partial derivative around Δf=0, and is expressed by Equation (15).

$$\begin{matrix}[ Math . 15 ] & \\ \begin{matrix}{b}_{1} ( f ) = {( \frac{\partial {ϕ}_{TRx} ( f , Δ f )}{\partial Δ f} )}_{Δ f = 0} \\ = \frac{d {ϕ}_{Rx} ( f )}{df}\end{matrix} & ( 15 )\end{matrix}$$

Equation (15) is derived from Equation (9). The phase characteristic separation unit 424 calculates φ_{Rx}(f) by integrating b₁(f) with a frequency f (Equation (16)).

$$\begin{matrix}[ Math . 16 ] & \\ \begin{matrix}\int {b}_{1} ( f ) df = \int \frac{d {ϕ}_{Rx} ( f )}{df} df \\ = {ϕ}_{Rx} ( f ) + D\end{matrix} & ( 16 )\end{matrix}$$

In Equation (16), D is an integral constant. The phase characteristic separation unit 424 calculates φ_{Tx}(f) based on b₀(f) and φ_{Rx}(f). b₀(f) is expressed by Equation (17),

$$\begin{matrix}[ Math . 17 ] & \\ {b}_{0} ( f ) = {ϕ}_{TRx} ( f , 0 ) = {ϕ}_{Rx} ( f ) + {ϕ}_{Tx} ( f ) & ( 17 )\end{matrix}$$

Therefore, the phase characteristic separation unit 424 calculates φ_{Tx}(f) by Equation (18) based on Equations (16) and (17).

$$\begin{matrix}[ Math . 18 ] & \\ \begin{matrix}{ϕ}_{Tx} ( f ) = {b}_{0} ( f ) - {ϕ}_{Rx} ( f ) \\ = {b}_{0} ( f ) - \int {b}_{1} ( f ) df + D\end{matrix} & ( 18 )\end{matrix}$$

Since the DC component of the phase characteristic is 0 in the transmitter and the receiver in the baseband region, the phase characteristic separation unit 424 determines D to satisfy φ_{Tx}(0)=0 and φ_{Tx}(0)=0. Thus, the phase characteristic separation unit 424 can calculate φ_{Tx}(f) and φ_{Rx}(f).

The optical transmitter transfer function calculation unit 425 calculates the transmission transfer function H_{Tx}(f) by Equation (19) based on A_{Tx}(f) and φ_{Tx}(f).

$$\begin{matrix}[ Math . 19 ] & \\ {H}_{Tx} ( f ) = {10}^{\frac{{A}_{Tx} ( f )}{20}} exp ( j {ϕ}_{Tx} ( f ) ) & ( 19 )\end{matrix}$$

The optical receiver transfer function calculation unit 426 calculates a transfer function H_{Rx}(f) of the optical receiver by Equation (20) based on A_{Rx}(f) and φ_{Rx}(f).

$$\begin{matrix}[ Math . 20 ] & \\ {H}_{Rx} ( f ) = {10}^{\frac{{A}_{Rx} ( f )}{20}} exp ( j {ϕ}_{Rx} ( f ) ) & ( 20 )\end{matrix}$$

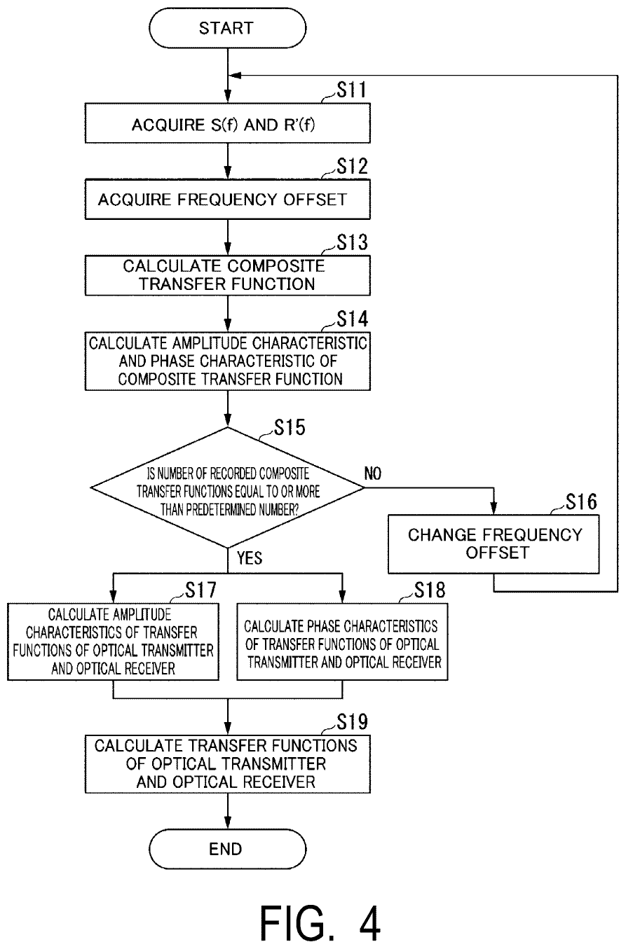

FIG. 4 is a flowchart illustrating an operation of the transfer function estimation device 4. First, the composite transfer function calculation unit 41 acquires S(f) from the optical transmitter 2, and acquires R′(f+Δf) from the optical receiver 3 (step S11). The composite transfer function calculation unit 41 acquires a frequency offset Δf from the optical receiver 3 (step S12). The composite transfer function calculation unit 41 calculates a composite transfer function by dividing S(f) from R′(f+Δf), and records the result in the storage unit 43 (step S13). The amplitude characteristic calculation unit 421 calculates amplitude characteristics of the composite transfer function, and the phase characteristic calculation unit 422 calculates phase characteristics of the composite transfer function, and records the calculated amplitude characteristics and phase characteristics (step S14). When the number of composite transfer functions different by the frequency offset Δf recorded in the storage unit 43 is less than a predetermined number (step S15: No), the frequency offset Δf is changed by adjusting the frequency f_{sig} of the carrier wave output from the transmission light source 22 and the frequency fₗₒ of the carrier wave output from the local light source 31 (step S16). The adjustment of the frequency offset may be controlled by a computer or by a user,

When the number of composite transfer functions different by the frequency offset Δf recorded in the storage unit 43 is equal to or more than a predetermined number (step S15: No), the amplitude characteristic separation unit 423 calculates amplitude characteristics of the transmission transfer function and the reception transfer function by performing polynomial fitting of amplitude characteristics of the composite transfer function (step S17). In addition, the phase characteristic separation unit 424 calculates phase characteristics of the transmission transfer function and the reception transfer function by performing polynomial fitting of the phase characteristics of the composite transfer function (step S18). The optical transmitter transfer function calculation unit 425 calculates a transmission transfer function from amplitude characteristics and phase characteristics of the transmission transfer function, and the optical receiver transfer function calculation unit 426 calculates a reception transfer function from amplitude characteristics and phase characteristics of the reception transfer function (step S19).

In the flowchart described above, the transfer function separation unit 42 calculates the transmission transfer function and the reception transfer function when the number of composite transfer functions different by the frequency offset Δf recorded in the storage unit 43 is equal to or more than a predetermined number, but the transfer function separation unit 42 may calculate the transmission transfer function and the reception transfer function regardless of the number of composite transfer functions different by the frequency offset Δf recorded in the storage unit 43. Further, the transfer function separation unit 42 changes a frequency offset after calculating the transmission transfer function and the reception transfer function, newly calculates the composite transfer function, the amplitude characteristics of the composite transfer function, and the phase characteristics of the composite transfer function, and calculates the transmission transfer function and the reception transfer function again based on the newly calculated amplitude characteristics of the composite transfer function and phase characteristics of the composite transfer function, and thus, the transmission transfer function and the reception transfer function may be updated.

### Experimental Example

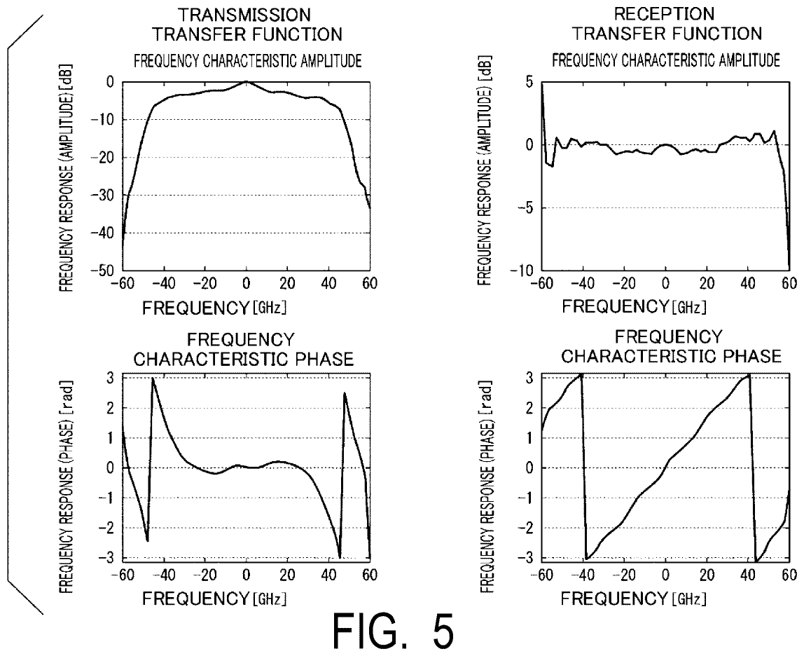

The optical transmitter 2 performs digital-analogue conversion of a signal subjected to digital signal processing by a digital-analogue converter having a sampling rate of 120 GSa/s, and generates and outputs an optical modulation signal using a modulation signal having a modulation rate of 120 GBaud. A signal received by the optical receiver 3 through the optical transmission line 100 is converted by an analogue-to-digital converter of 256 GSa/s and converted to a sampling speed of 120 GSa/s by digital signal processing. The frequency offset Δf was changed from −3000 MHz to 3000 MHz at 500 MHz intervals to calculate a different composite transfer function by Δf, and then the transmission transfer function and the reception transfer function were calculated. The digital-to-analogue converter of the optical transmitter 2 has a cut-off at about 50 GHz of the amplitude characteristic, the analogue-to-digital converter of the optical receiver 3 has a sufficiently wide frequency band, and the phase characteristic is linear. FIG. 5 is a diagram illustrating amplitude characteristics and phase characteristics of the transmission transfer function and the reception transfer function calculated by the transfer function estimation device 4. The cut-off near 50 GHz can be confirmed for the amplitude characteristic in the transmission transfer function. In addition, the amplitude characteristic in the reception transfer function is approximately constant at 50 GHz which is a cut-off in the transmission signal, and the phase characteristic is linear. From the above, it is understood that the transmission transfer function and the reception transfer function can be calculated respectively.

Thus, the transfer function estimation device 4 can estimate the transmission transfer function and the reception transfer function without a white noise source unlike the conventional method. In addition, unlike the prior art, it is not necessary to calculate a temporary reception-side transfer function or the like, and the transmission transfer function and the reception transfer function are estimated with fewer steps to shorten the estimation time. Further, since the amplitude characteristic and phase characteristic of the composite transfer function depend only on the amplitude characteristic and phase characteristic of the receiver with respect to the change of the frequency offset Δf, it is possible to prevent the phase characteristic of the transmission transfer function and the phase characteristic of the reception transfer function from being mixed.

### Other Embodiments

The composite transfer function calculation unit 41 calculates H_{Rx} (f+Δf)H_{Tx}(f) as the composite transfer function H_{TRx} (f, Δf), but is not limited to this. For example, H_{Rx}(f) H_{Tx} (f−Δf) may be calculated as a composite transfer function by Equation (4) and S(f−Δf). When the composite transfer function calculation unit 41 calculates H_{Rx}(f) H_{Tx} (f−Δf) as the composite transfer function H_{TRx} (f, Δf), since the amplitude characteristic of the composite transfer function depends only on the amplitude characteristic of the transfer function of the transmitter with respect to the change of Δf and the phase characteristics of the composite transfer function depends only on the phase characteristic of the transfer function of the transmitter with respect to changes in Δf, the transfer function separation unit 42 similarly performs polynomial fitting. Thereafter, the transfer function separation unit 42 calculates A_{Rx}(f) after calculating A_{Tx}(f), calculates φ_{Rx}(f) after calculating φ_{Tx}(f), and calculates H_{Tx}(f) and H_{Rx}(f).

### REFERENCE SIGNS LIST

1 Transmission and reception system
2 Optical transmitter
21 Modulation signal generation unit
22 Transmission light source
23 Optical modulation unit
3 Optical receiver
31 Local light source
32 Optical demodulation unit
33 Signal processing unit
4 Transfer function estimation device
41 Composite transfer function calculation unit
42 Transfer function separation unit
421 Amplitude characteristic calculation unit
422 Phase characteristic calculation unit
423 Amplitude characteristic separation unit
424 Phase characteristic separation unit
425 Optical transmitter transfer function calculation unit
426 Optical receiver transfer function calculation unit
43 Storage unit

1. A transfer function estimation device comprising:
a composite transfer function calculator that calculates a composite transfer function which is obtained by combining a transmission transfer function that affects a signal transmitted by an optical transmitter and a reception transfer function that affects a signal received by an optical receiver in each of frequency offsets that are differences between a frequency of a carrier wave input to an optical modulation unit in the optical transmitter and a frequency of a carrier wave input to an optical demodulation unit in the optical receiver based on a signal transmitted by the optical transmitter and a signal received by the optical receiver; and
a transfer function separator that calculates the transmission transfer function and the reception transfer function from the composite transfer function based on dependency of the composite transfer function on the frequency offset.

2. The transfer function estimation device according to claim 1, wherein the transfer function separator includes
an amplitude characteristic calculator that calculates an amplitude characteristic of the composite transfer function,
a phase characteristic calculator that calculates a phase characteristic of the composite transfer function,
an amplitude characteristic separator that calculates an amplitude characteristic of the transmission transfer function and an amplitude characteristic of the reception transfer function based on dependency of an amplitude characteristic of the composite transfer function on the frequency offset,
a phase characteristic separator that calculates a phase characteristic of the transmission transfer function and a phase characteristic of the reception transfer function based on dependency of a phase characteristic of the composite transfer function on the frequency offset,
an optical transmitter transfer function calculator that calculates the transmission transfer function based on the amplitude characteristic and the phase characteristic of the transmission transfer function, and
an optical receiver transfer function calculator that calculates the reception transfer function based on the amplitude characteristic and the phase characteristic of the reception transfer function.

3. The transfer function estimation device according to claim 2, wherein the amplitude characteristic separator calculates the amplitude characteristic of the transmission transfer function and the amplitude characteristic of the reception transfer function by performing polynomial fitting of the amplitude characteristic of the composite transfer function to the frequency offset, and the phase characteristic separator calculates the phase characteristic of the transmission transfer function and the phase characteristic of the reception transfer function by performing polynomial fitting of the phase characteristic of the composite transfer function to the frequency offset.

4. A transfer function estimation method comprising:
calculating a composite transfer function which is obtained by combining a transmission transfer function that affects a signal transmitted by an optical transmitter and a reception transfer function that affects a signal received by an optical receiver in each of frequency offsets that are differences between a frequency of a carrier wave input to an optical modulation unit in the optical transmitter and a frequency of a carrier wave input to an optical demodulation unit in the optical receiver based on a signal transmitted by the optical transmitter and a signal received by the optical receiver; and
calculating the transmission transfer function and the reception transfer function from the composite transfer function based on dependency of the composite transfer function on the frequency offset.

5. A non-transitory storage medium storing a program for causing a computer to operate as the transfer function estimation device according to claim 1.
